(19) United States
(12) Patent Application Publication
(10) Pub. No.: US 2012/0182944 A1
(43) Pub. Date: Jul. 19, 2012

(54) METHODS AND ARRANGEMENTS FOR SIGNALING CHANNEL STATE INFORMATION

(75) Inventors: Stefano Sorrentino, Solna (SE); David Hammarwall, Vallentuna (SE)

(73) Assignee: TELEFONAKTIEBOLAGET LM ERICSSON (PUBL), Stockholm (SE)

(21) Appl. No.: 13/265,300

(22) PCT Filed: Sep. 23, 2011
(86) PCT No.: PCT/SE11/51142

§ 371 Date: Oct. 19, 2011

Related U.S. Application Data
(60) Provisional application No. 61/434,143, filed on Jan. 19, 2011.

(51) Int. Cl. H04W 72/04

(52) U.S. Cl. 370/329

(57) ABSTRACT

Particular embodiments provide a method in a network node (110) for requesting a channel state information-only, CSI-only, report from a wireless terminal (120). The method comprises selecting (210), based on at least one parameter related to transmission of the CSI-only report, a transport block out of two or more available transport blocks, such that the at least one parameter is derivable from an indication of which transport block was selected. The network node then transmits (220) an uplink grant to the wireless terminal (110). The uplink grant comprises the request for the CSI-only report, and also comprises an indication of the selected transport block.

### TECHNICAL FIELD

The present invention relates generally to methods and arrangements in a wireless communications system. In particular it relates to techniques for requesting and signaling channel state information.

### BACKGROUND

Multi-antenna techniques can significantly increase the data rates and reliability of a wireless communication system. In particular, throughput and reliability can be drastically improved if both the transmitter and the receiver are equipped with multiple antennas. This arrangement results in a so-called multiple-input multiple-output (MIMO) communication channel; such systems and related techniques are commonly referred to as MIMO systems and MIMO techniques.

The Long Term Evolution (LTE) Release 10 standard, also referred to as LTE-Advanced, is currently under development by the 3^{rd} Generation Partnership Project (3GPP). A core component in LTE-Advanced is the support of MIMO antenna deployments and MIMO related techniques for both downlink (base station to mobile station) and uplink (mobile station to base station) communications. More particularly, a spatial multiplexing mode (single-user MIMO, or “SU-MIMO”) for uplink communications is being designed. SU-MIMO is intended to provide mobile stations (user equipment, or “UEs” in 3GPP terminology) with very high uplink data rates in favorable channel conditions.

SU-MIMO consists of the simultaneous transmission of multiple spatially multiplexed data streams within the same bandwidth, where each data stream is usually referred to as a “layer.” Multi-antenna techniques such as linear precoding are employed at the UE's transmitter in order to differentiate the layers in the spatial domain and to allow the recovering of the transmitted data at the receiver of the base station (known as eNodeB, or eNB, in 3GPP terminology).

Another MIMO technique supported by LTE-Advanced is MU-MIMO, where multiple UEs belonging to the same cell are completely or partly co-scheduled in the same bandwidth and during the same time slots. Each UE in a MU-MIMO configuration may transmit multiple layers, thus operating in SU-MIMO mode.

The concept of carrier aggregation (CA), or “multi-carrier” operation, has also been introduced in LTE Release 10 in order to support bandwidths wider than 20 MHz in a backward-compatible way. With carrier aggregation, an LTE Release 10 terminal can receive multiple component carriers (CCs), where each component carrier has the same structure as a Release 8 carrier of 20 MHz. This allows Release 10 mobile terminals to operate over a wider bandwidth and exploit higher data rates, while legacy terminals can be scheduled in any one of the component carriers.

Channel-dependent scheduling and link adaption are important components in maximizing the spectral efficiency of modern wireless communication systems. To enable such functionality, the channel quality or channel properties, i.e., data characterizing the propagation channels, or channels, between the transmitter and receiver, need to be known on the transmitter side. For this purpose, channel state information (CSI) such as channel quality indicators (CQIs) are typically fed back from the receiver to the transmitter. Such CQI feed back may be periodic, meaning, for example, that a CQI report is conveyed to the transmitter every N milliseconds. The parameters for CQI reporting are typically semi-statically configured.

For CQI reports with a small payload size, periodic reporting may be adequate. But if more detailed CQI reports of larger payload size are needed, then a more flexible mechanism for scheduling CQI reporting is desirable in order to avoid tying up resources in the reverse link that might not otherwise be used, e.g., since there is no data for the corresponding UE. In essence, it may be beneficial to have the ability for the transmitter to request a CQI report from the receiver at a predefined time instant. In contrast to the semi-statically configured periodic reporting, such aperiodic scheduling of CQI reports, allows the CQI reports to be both quickly enabled and disabled.

LTE supports both periodic and aperiodic CQI reporting. Periodic reporting is available on the Physical Uplink Control Channel (PUCCH) and is semi-statically configured via higher layer signaling. Aperiodic CQI reporting is transmitted on the Physical Uplink Shared Channel (PUSCH). The PUSCH is normally used for transmitting user plane data from the user equipment (UE) to the eNodeB and is scheduled by transmitting an uplink grant on the Physical Downlink Control Channel (PDCCH). A CQI report can be piggybacked on the data transmitted over the PUSCH by setting the CQI poll bit in the uplink grant to a certain value. The value of this bit determines whether CQI should be included in the PUSCH transmission or not.

As long as there is a fair amount of uplink traffic, CQI can be piggybacked on data that already needs to be transmitted, thus causing no increase in the use of uplink grants, and consuming, in most typical cases, only a modest portion of the uplink capacity. Even with a very asymmetric traffic pattern comprising mostly downlink traffic, there is typically still plenty of uplink traffic in the form of TCP ACK/NACKs. There are, however, scenarios in which solely relying on piggybacking CQI reports on data is not sufficient and in which there is a need to explicitly request a CQI-only report, or more generally, a CSI-only report, on the PUSCH. To clarify, one particular example of a CSI-only report is a CQI-only report. However, a CSI-only report may comprise other or additional data, e.g. a rank indicator. A traffic pattern with scarce TCP ACK/NACK transmissions, e.g. a link relying on the User Datagram Protocol (UDP), constitutes one example of a scenario where requesting a CSI-only or CQI-only report would be beneficial.

In an LTE network, the base station (eNB) commands the transmission schemes to be adopted by the UEs, according to scheduling decisions made by the eNB. These decisions are communicated to the UEs by use of downlink control information (DCI) that is carried by the downlink control channel (PDCCH).

More specifically, the downlink control information includes:
Downlink scheduling assignments, including, e.g., PDSCH resource indication, transport format, hybrid-Automatic Repeat reQuest (hybrid-ARQ) information, and control information related to spatial multiplexing, if applicable. A downlink scheduling assignment also includes a command for power control of the PUCCH uplink physical channel.
Uplink scheduling grants, including PUSCH resource indication, transport format, e.g. Modulation and Coding Scheme (MCS), hybrid-ARQ related information and control information related to spatial multiplexing, if applicable. An uplink scheduling grant also includes a command for power control of the PUSCH uplink physical channel.
Power-control commands for a set of terminals as a complement to the commands included in the scheduling assignments or scheduling grants.

The different types of control information above typically correspond to different DCI message sizes. For example, supporting spatial multiplexing with non-contiguous allocation of resource blocks in the frequency domain requires a larger scheduling message, compared to an uplink grant allowing for frequency-contiguous allocations only. The downlink control information is therefore categorized into different DCI formats, where each format corresponds to a certain message size and usage. The actual message size depends on the cell bandwidth, as for larger bandwidths a larger number of bits is required to indicate the resource block allocation.

One PDCCH carries one message with one of the supported DCI formats. Since multiple terminals can be scheduled simultaneously, on both downlink and uplink, there should be a possibility to transmit multiple scheduling messages within each subframe. Each scheduling message is transmitted on a separate PDCCH; consequently there are typically multiple simultaneous PDCCH transmissions within each cell. Furthermore, to support different radio-channel conditions, link adaptation, where the code rate of the PDCCH is selected to match the radio-channel conditions, may be used. Thus, there will be multiple PDCCH formats where the PDCCH format to use depends on the DCI format and on the code rate used for the PDCCH transmission.

Uplink scheduling grants use at least two different DCI formats: DCI format 0 for single antenna transmission and DCI format 4 for multi-antenna operations. Non-contiguous resource block allocations are supported for both DCI formats 0 and 4, while spatial multiplexing from a single terminal (SU-MIMO) is currently supported only for DCI format 4.

A scheduled PUSCH transmission from a UE is achieved by transmission of up to 2 parallel-coded transport blocks (TBs), each of them associated with an independent HARQ process. Because the HARQ processes for these transport blocks are independent, it is possible to individually retransmit each transport block and to assign transport block-specific parameters such as the modulation and coding scheme (MCS).

DCI Format 0 (DCI-0): DCI format 0 has the same size for the control signaling message as the “compact” downlink assignment (DCI format 1A, described in detail in 3GPP TS 36.212, version 10.2.0, section 5.3.3.1.3). A flag in the message is used to inform the terminal whether the message is an uplink scheduling grant (DCI format 0) or a downlink scheduling assignment (DCI format 1A). The information fields of DCI format 0 include:
Format 0/1A indication [1 bit], used to differentiate between DCI format 1A and DCI format 0, since the two formats have the same message size.
Hopping flag [1 bit], indicating whether or not uplink frequency hopping is to be applied to the uplink PUSCH transmission.
Resource-block allocation. This field, also denoted N_PRB or NPRB, indicates the resource blocks upon which the terminal should transmit the PUSCH.
Modulation and coding scheme including redundancy version [5 bits], also denoted I_MCS. This field is used to provide the terminal with information about the modulation scheme, the code rate and the transport-block size. For the uplink, the signaling of the transport block size uses the same transport block table as for the downlink, i.e., the modulation and coding scheme together with the number of scheduled resource blocks provides the transport block size.
The new-data indicator [1 bit], NDI, is used to clear the soft buffer for initial transmissions.
Phase rotation of the uplink demodulation reference-signal [3 bits]. Multiple terminals can be scheduled to transmit upon the same set of resource blocks, but if the uplink demodulation reference signals are distinguishable through different phase rotations, the eNodeB can estimate the uplink channel response from each terminal and suppress the inter-terminal interference by the appropriate processing. This is sometimes referred to as multi-user MIMO.
Channel status request flag [1 bit]. The network can explicitly request an aperiodic channel status report by setting this bit in the uplink grant.
Uplink index [2 bits]. This field is present only when operating in TDD and is used to signal for which uplink subframe the grant is valid.
Transmit-power control for PUSCH [2 bits].
Identity (Radio Network Temporary Identifier, RNTI) of the terminal for which the PDSCH transmission is intended [16 bits]. The identity is not explicitly transmitted but implicitly included in the CRC calculation.
Non-continuous resource allocation flag.

There is no explicit signaling of the redundancy version in the uplink scheduling grants. This is motivated by the use of a synchronous hybrid-ARQ protocol in the uplink; retransmissions are normally triggered by a negative acknowledgement on the PHICH and not explicitly scheduled as for downlink data transmissions. Nevertheless, there is still a possibility to explicitly schedule retransmissions. This is useful in situations where the network wishes to explicitly move the retransmission in the frequency domain, and is done by using the PDCCH instead of the PHICH. Three values of the modulation and coding field are reserved to mean redundancy versions one, two and three. If one of those reserved MCS values are signaled, the terminal should assume that the same modulation and coding as the original transmission is used. The remaining MCS values are used to explicitly signal the modulation and coding scheme the terminal should use, and signaling of these MCS values also imply that redundancy version zero should be used. The difference in usage of the reserved values compared to the downlink scheduling assignments means that the modulation scheme cannot change between uplink transmission and retransmission attempts, in contrast to the downlink case.

The time between reception of an uplink scheduling grant on a PDCCH and the corresponding transmission on the uplink-SCH is fixed. For FDD, the time relation is the same as for PHICH, that is, an uplink grant received in downlink subframe n applies to uplink subframe n+4. The reason for having the same timing relation as for PHICH is the possibility to override the acknowledgment on PHICH with a scheduling grant on PDCCH. For TDD, such a time relation is not possible, since subframe n+4 may not be an uplink subframe. Therefore, for some downlink-uplink configurations, the delay between the reception of an uplink scheduling grant and the actual transmission differs between subframes, depending on the subframe in which the uplink scheduling grant was received. Furthermore, in one of the downlink-uplink asymmetries for TDD, configuration 0, there are more uplink subframes than downlink subframes, i.e., three uplink subframes versus two downlink subframes. Therefore, there is a need to be able to schedule multiple uplink subframes in one downlink subframe; if this was not possible then it would be impossible to schedule all uplink subframes in some configurations. Consequently, a two-bit uplink index field is part of the uplink scheduling grant. The index field specifies which uplink subframe a grant received in a downlink subframe applies to.

CQI-only triggering with DCI format 0 is achieved via a combination of I_MCS=29, a value otherwise used to indicate a retransmission, and indication of a small number of allocated Physical Resource Blocks (PRBs) needed for CQI-only transmission in the N_PRB field. In Rel-8/9 a value N_PRB<=4 is employed for triggering CQI-only and disabling data transmission. This combination results in a marginal scheduling restriction, since multiplexing a retransmitted data and CQI within such a small number of PRBs is not a favorable grant assignment. Because the MCS field is used to indicate a CQI-only request, there is no way to explicitly signal a modulation and coding scheme to the mobile terminal. Thus, in the event of CQI-only transmission, QPSK modulation is always employed for the CQI payload according to the current standard.

DCI Format 4 (DCI-4): The details regarding the content and encoding of DCI format 4 are currently under discussion by 3GPP. The working assumption is that DCI format 4 is used for the scheduling of PUSCH in one uplink cell with multi-antenna port transmission mode, and that the downlink cell from which PUSCH assignments for a given uplink cell originate is configured by higher layers.

A number of information elements (IEs) are transmitted by means of the DCI format 4 including control information regarding uplink radio resources assignment, uplink power control, reference signals assignment for demodulation of uplink data transmission, frame structure configuration for flexible TDD and FDD modalities and triggering of uplink reports regarding properties of the radio channel and/or the recommended format for downlink transmissions (CQI). Additional details about DCI-4 are present in 3GPP documentation, including in documents R1-106556, “Introduction of Rel-10 LTE-Advanced features in 36.212,” and R1-106557, “Introduction of Rel-10 LTE-Advanced features in 36.213,” available via http://www.3gpp.org.

Furthermore, DCI-4 is used to assign the transport format for uplink data transmission on PUSCH. Since up to two codewords can be scheduled on PUSCH in the same subframe, and each codeword is associated with a unique transport block, it is necessary to specify the transport format for up to two transport blocks for each PUSCH transmission, i.e., for each DCI-4. In case a single transport block is employed, e.g. for rank-1 PUSCH, it is also necessary to indicate which transport block is employed. Since each transport block might possibly contain either the retransmission of a previously scheduled transport block or new data, a New Data Indicator (NDI) information element is associated with each transport block.

The resource assignment in frequency domain is common to both codewords on PUSCH, and is determined by an N_PRB field in DCI-4. This field indicates the common number of resource blocks, i.e., the scheduled bandwidth, for both codewords on the corresponding PUSCH transmission.

The transport format assignment is performed by use of a transport block-specific I_MCS(b) field, where b indicates the transport block index.

In order to reduce the payload of DCI-4 and provide a compact signaling procedure for transport block selection, or equivalently transport block disabling, the disabled transport block index is obtained from the MCS and resource allocation for PUSCH as follows:
If either (I_MCS(b)=0, N_PRB>1) or (I_MCS(b)=28, N_PRB=1) is signaled, the corresponding transport block b is disabled.

DCI-4 is also able to trigger Sounding Reference Signals (SRS) in the uplink and to configure certain associated properties. SRS are transmitted in the uplink either in a periodic or aperiodic fashion, and are intended to provide additional reference signals for estimating some radio channel properties.

Another information element included in DCI-4 is rank and precoder information for the corresponding PUSCH transmission. Transmission rank index (TRI), alternatively referred to as simply rank index (RI), and precoder matrix index (TPMI or simply PMI) are jointly encoded. In case of 2 and 4 antenna port UEs, the following TPMI codebook lengths are defined:

| | Number of supported | Number of supported |
|---|---|---|
| | TPMI values | TPMI values |
| Transmission rank | (2 antenna ports) | (4 antenna ports) |
| 1 | 6 | 24 |
| 2 | 1 | 16 |
| 3 | Not applicable | 12 |
| 4 | Not applicable | 1 |

In case of 2 antenna ports, the RI/PMI is defined as a 3-bit field (one code point is reserved) while in case of 4 antenna ports a 6-bit TRI/TPMI field is defined.

In order to achieve a convenient compromise between resource allocation flexibility and compactness of the associated signaling it is defined that single transport block transmission is supported only for rank-1 (2 tx, i.e. two transmit antennas, and 4 tx) and rank-2 (only for 4 tx), while transmission of two transport blocks is supported for rank-2, rank-3 and rank-4.

DCI-4 also includes 1 or 2 bits for triggering CQI reports. One combination of bits (“0” or “00”) indicates no CQI report, while the remaining combinations may be used to indicate different sets of downlink component carriers for which the CQI reports need to be transmitted. The details of how to trigger CQI-only for DCI-4 are currently under discussion in standardization. According to the current agreement, the meaning of “10” and “11” may be configured by a Radio Resource Configuration (RRC) message, while “01” indicates a trigger for the downlink component carrier that is linked, via a so-called SIB-2 link, to the uplink component carrier transmitting the CSI report.

In Releases 8 and 9 of the 3GPP standards, only one transport block (TB) is available for CQI transmission. When more than one downlink component carriers are assigned in Release 10, the CQI payload increases compared to Release 8, as a CQI report for each component carrier is potentially supported. Thus, a larger number of physical resource blocks for CQI allocation needs to be considered, as compared to Rel-8/9, in order to accommodate the CQI payload.

In Rel-8/9, CQI-only mode is triggered by the combination of I_MCS=29 and N_PRB<=X (X=4 in Rel-8/9). As a consequence I_MCS=29 cannot be selected for UEs scheduled on a bandwidth not larger than X PRBs, when CQI reporting is enabled, resulting in a scheduling restriction. The value X=4 is considered in Rel-8/9, as it represents the maximum number of PRB that are deemed necessary for signaling CQI for a single carrier.

In case of multi-carrier operation, it is desirable to be able to include the CQI for more than one component carrier in a single CQI-only report. A Release-10 UE may have up to five activated component carriers; however, the eNB is typically interested in receiving feedback for only a subset of the component carriers at a given time. There is thus a need to be able to dynamically adapt the set of, and number of carriers to be included in the CQI report in order to match congestion in the signaling channel, traffic conditions, buffer status and other dynamic parameters. However, the three available bit combinations in the CQI triggering field are not sufficient for indicating all possible combinations of up to five component carriers. Dynamic selection of the subcarriers to be signaled is achievable in a straightforward way by providing the DCI format, or a message on another control channel, with an explicit signaling field. However, an increase of the payload size for a DCI format, or another signaling grant, would lead to subsequent drawbacks such as increased congestion on the signaling channel and reduced reliability of the signaling channel.

3GPP contribution number R1-110090 discusses signaling design for CSI-only transmissions. The contribution proposes that when more than two CSI reports are transmitted, 16QAM should be used for CSI modulation, otherwise QPSK should be used. As an alternative solution, the contribution discloses that the new data indicator (NDI) bit of a disabled transport block may be used to indicate if 16QAM should be used for CSI modulation.

There still exists a need in the art for efficient mechanisms for signaling information related to CSI-only transmission.

### SUMMARY

An object of particular embodiments is to provide an efficient mechanism for signaling information related to CSI-only transmission. A further object of some embodiments is to enable flexible yet efficient signaling of such information.

Particular embodiments provide a method in a network node for requesting a channel state information-only, CSI-only, report from a wireless terminal. The method comprises selecting a transport block, out of two or more available transport blocks, based on at least one parameter related to transmission of the CSI-only report which is to be requested, such that the at least one parameter is derivable from an indication of which transport block was selected. The network node then transmits an uplink grant to the wireless terminal. This uplink grant comprises the request for the CSI-only report, and also comprises an indication of the selected transport block.

Further embodiments provide a method in a wireless terminal for transmitting a channel state information-only, CSI-only, report to a network node. According to the method, the wireless terminal receives an uplink grant, which comprises a request for a CSI-only report. The uplink grant indicates a selected transport block, out of two or more available transport blocks. The wireless terminal then derives at least one parameter related to transmission of the CSI-only report based on the indication of the selected transport block, and transmits the CSI-only report according to the derived parameter.

Yet further embodiments provide a network node for requesting a channel state information-only, CSI-only, report from a wireless terminal. The network node comprises radio circuitry and one or more processing circuits. The one or more processing circuits are configured to select a transport block out of two or more available transport block. The selection is based on at least one parameter related to transmission of the CSI-only report which is to be requested, such that the at least one parameter is derivable from an indication of which transport block was selected. The processing circuits are further configured to transmit an uplink grant to the wireless terminal, via the radio circuitry. The uplink grant comprises the request for the CQI-only report, and an indication of the selected transport block.

Particular embodiments provide a wireless terminal for transmitting a channel state information-only, CSI-only, report to a network node. The wireless terminal comprises radio circuitry and one or more processing circuits. The one or more processing circuits are configured to receive, via the radio circuitry, an uplink grant comprising a request for a CSI-only report. The uplink grant indicates a selected transport block, out of two or more available transport blocks. The processing circuits are further configured to derive at least one parameter related to transmission of the CSI-only report based on the indication of the selected transport block, and to transmit the CSI-only report via the radio circuitry according to the derived parameter.

Some embodiments make it possible to transmit parameters related to CSI-only transmission without any additional signaling overhead, or at least with reduced overhead. This is achieved by encoding information related to these parameters in the indication of the transport block comprised in the uplink grant sent from the network node to the wireless terminal.

Some particular embodiments use the transport block indication in conjunction with other bits in the uplink grant, e.g. the NDI bit or bits in the CSI request field, to encode information related to CSI-only transmission. This makes it possible to signal more complex information, while requiring no, or at least no significant amount of additional overhead.

### BRIEF DESCRIPTION OF THE DRAWINGS

FIG. 1 is a schematic diagram showing an example wireless communication network.

FIG. 1a is a combined signaling diagram and flow chart illustrating a method according to some embodiments.

FIG. 2 is a flow chart illustrating a method according to some embodiments.

FIG. 3 is a flow chart illustrating a method according to some embodiments.

FIG. 4 is a flow chart illustrating a method according to some embodiments.

FIG. 5 is a flow chart illustrating a method according to some embodiments.

FIG. 6 is a block diagram illustrating components of a wireless node, such as a mobile station or a base station, according to several embodiments of the present invention.

### ABBREVIATIONS

### ACK Acknowledged

### CSI Channel State Information

### CQI Channel Quality Indicator

### DCI Downlink Control Information

### DL Downlink

FH Frequency hopping
FFS For further study

### HARQ Hybrid ARQ

IE Information element
MCSx Modulation and coding scheme for TBx (Information Element in the DCI formats)
NACK Not acknowledged
NDI New Data Indicator (Information Elements in the DCI formats)
PDCCH Physical downlink control channel
PMI, TPMI Precoder matrix indicator (Information Elements in the DCI formats)
PUSCH Physical uplink shared data channel
RI, TRI Transmission rank indicator
SRS Sounding reference signals
TB Transport block
TBx Transport block number x
TxDiv Transmit diversity

### UL Uplink

### DETAILED DESCRIPTION

Various embodiments of the present invention will now be described with reference to the drawings, wherein like reference numerals are used to refer to like elements throughout. In the following description, numerous specific details are set forth for purposes of explanation, in order to provide a thorough understanding of one or more embodiments. It will be evident to one of ordinary skill in the art, however, that some embodiments of the present invention may be implemented or practiced without one or more of these specific details. In other instances, well-known structures and devices are shown in block diagram form in order to facilitate describing embodiments.

In the following, proposed methods for signaling CQI-related parameters for CQI-only transmission are described for the case of a DCI-4 scheduling grant. However, those skilled in the art will appreciate that these techniques are more broadly applicable. In particular, the described methods could be applied to other DCI formats, and to any kind of CSI-only transmission and CSI-related parameters.

In case of CQI-only transmission, the CQI payload is transmitted on a single codeword. Furthermore, according to Rel-8/9, CQI-encoding is associated with reduced link adaptation flexibility as compared to other PUSCH transmissions. In particular, it is observed that the modulation format for the CQI-only payload is limited to QPSK. Furthermore, the coding rate for CQI-only is not explicitly signaled but it is implicitly obtained from the allocation size, the CQI payload size and the pre-assigned modulation format.

However, it is observed here that when a DCI-4 grant is employed to trigger CQI-only transmission, redundant signaling fields are present in the grant.

Based on the above observations, the content and meaning associated to certain PUSCH-related fields in the DCI-4 grant may be dynamically redefined when CQI-only transmission is triggered. In particular, when CQI-only is triggered, such fields may carry parameters related to CQI encoding or the CQI payload instead of the conventional PUSCH-related parameters. Particular embodiments herein make use of the realization that the network may freely choose which transport block to enable, and which to disable. The transport block selection, which is indicated in the uplink grant, may therefore be utilized to encode CQI-related paramaters, such as modulation order, transmission rank, or an indication of which component carriers for which to report CQI. In some embodiments, the transport block selection may be combined with certain other redundant bits, such as the new data indicator (NDI) field, in order to signal more information, e.g. one larger parameter, or several parameters.

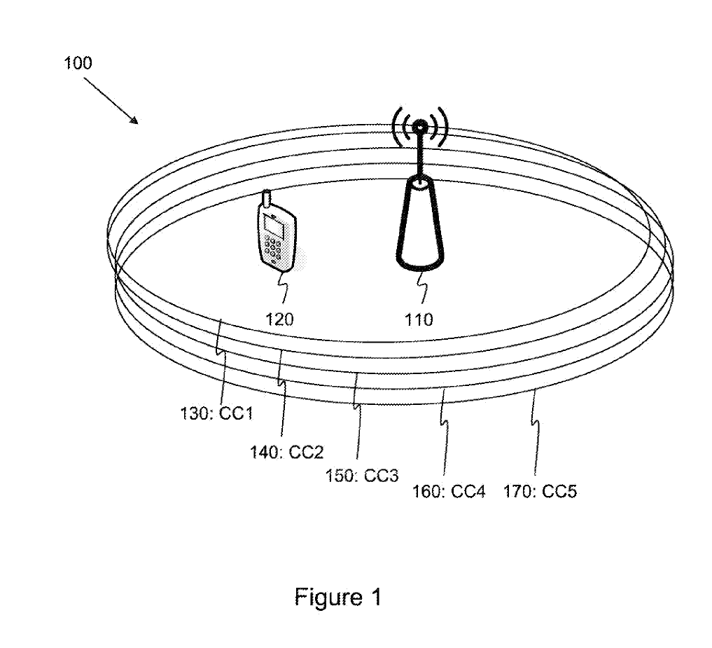

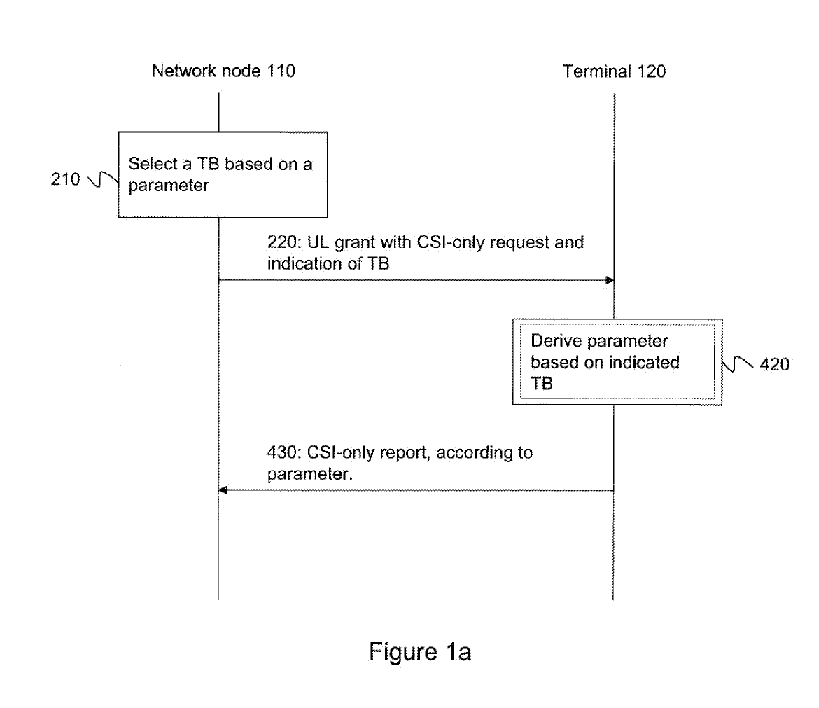

FIG. 1 illustrates an example wireless communications network 100 in which particular embodiments of the invention may operate. A wireless terminal 120 is served by a network node 110, e.g. an LTE eNodeB. The network node 110 operates on five component carriers 130-170. The wireless terminal 120 is a carrier aggregation-capable terminal, i.e. capable of receiving multiple component carriers, and the network node 110 has configured and activated two component carriers, 130 and 140 for mobile terminal 120. This example scenario should not be construed as limiting. It should be understood that any number of component carriers, i.e. 1, 2, 3, 4, or 5 carriers may be activated for wireless terminal 120. More than five component carriers may also become possible in future systems. Furthermore, FIG. 1 is schematic and does not necessarily illustrate the geographical coverage areas of the serving cells corresponding to component carriers 130-170. It is also noted that various embodiments of the invention may be applied in a non-carrier aggregation scenario.

It should be understood that the term “wireless terminal”, as used in this disclosure, comprises an LTE user equipment, UE, or in general any portable, pocket-storable, hand-held, computer-comprised, or vehicle-mounted device which is enabled to communicate voice and/or data wirelessly.

Furthermore, the term “network node” may refer to an LTE eNodeB, an UMTS NodeB, or any other node configured to communicate, directly or indirectly, with a wireless terminal.

Particular embodiments of a method for requesting and transmitting a CSI-only report in the system 100 will now be described, with reference to the combined signaling diagram and flowchart in FIG. 1a.

In step 210, network node 110 selects a transport block out of two or more available transport blocks. The selection is made based on the value of a parameter related to transmission of the CSI-only report, e.g. modulation order, CQI modality, transmission rank etc. Here, “value” is used in the sense of the current setting of the parameter, and is thus intended to encompass both numeric and non-numeric values, depending on the parameter type. For example, a selection of TB1 may correspond to QPSK modulation, and TB2 may correspond to 16QAM modulation. In other words, the “value” or setting of the modulation order parameter would be QPSK and 16QAM, respectively. As will be described in detail below, many other parameters and encodings are possible.

In step 220, the network node 110 transmits an uplink grant to the wireless terminal 120. The uplink grant comprises an indication of the selected transport block.

In step 420, the wireless terminal 120 derives the value of the parameter based on the indicated TB in the uplink grant. For example, if the uplink grant indicates TB1, the wireless terminal 120 derives QPSK as the modulation order.

Finally, in step 430, the wireless terminal 120 transmits the CSI-only report according to the indicated parameter. For example, the wireless terminal 120 transmits the CSI-only report with QPSK modulation.

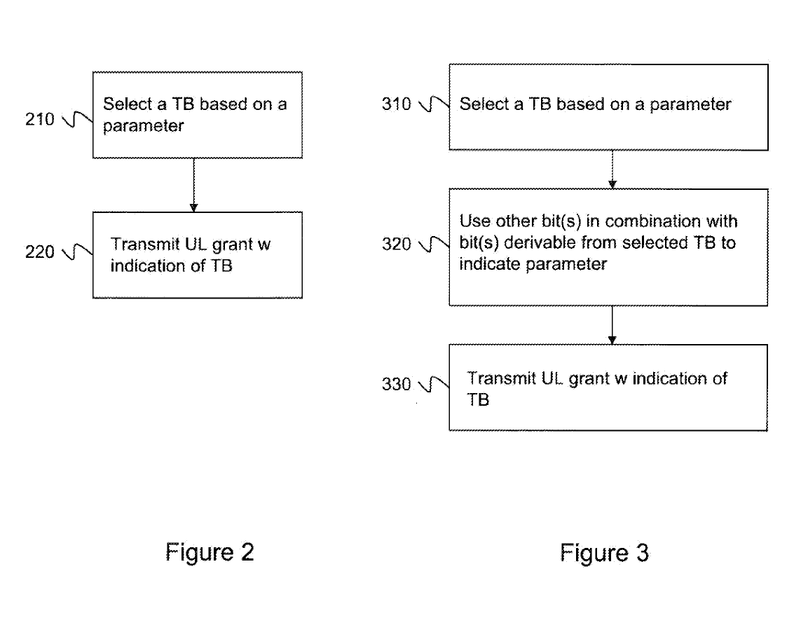

With reference to FIG. 1 and the flowchart in FIG. 2, an example method in a network node 110 for requesting a channel state information-only, CSI-only, report from a wireless terminal 120 will now be described. The network node 110 may be an LTE eNodeB and the wireless terminal 120 may be a user equipment, UE.

In step 210, network node 110 selects a transport block out of two or more available transport blocks. The selection is made based on a parameter related to transmission of the CSI-only report which is to be requested, such that the parameter is derivable from an indication of which transport block was selected. Stated differently, the parameter relates to the subsequent transmission of the CSI-only report by the wireless terminal 120. In this particular example, the parameter is the modulation order to use for transmitting the CSI-only report, and the transport block selection indicates whether QPSK or 16QAM modulation should be used. A selection of transport block 1 (TB1) indicates QPSK, and transport block 2 (TB2) indicates 16QAM. Thus, in this example, the modulation order may be derived from the index (1 or 2) of the selected transport block. Of course, it is equally possible to use any other encoding, as long as network node 110 and mobile terminal 120 both agree on which rule is to be applied. For instance, TB2 could indicate QPSK and TB1 could indicate 16QAM. The indexing of the transport blocks may also vary within the scope of this embodiment. TB1 may alternatively be referred to as TB0, for instance.

In step 220, the network node 110 transmits an uplink grant to the wireless terminal 120, e.g. using a DCI format such as DCI format 4. The transmission may be performed on the PDCCH. The uplink grant comprises a request for the CSI-only report. The uplink grant also comprises an indication of the selected transport block.

In one variant, the network node 110 provides the indication of which transport block is selected by setting the MCS field for the selected transport block in the uplink grant to 29, and by setting the NPRB field for the selected transport block, i.e. the field indicating how many physical resource blocks are assigned, to less than or equal to X, where X is a predefined value, e.g. 4. To clarify, the uplink grant comprises an MCS field and a NPRB field for each transport block. When a CSI-only report is to be requested, the network node 110 set the CSI request field, and then sets MCS=29 and NPRB<=4 for one of the transport blocks to indicate that this is the selected transport block. This corresponds to the currently standardized way of enabling a transport block. However, other ways of providing the indication are also possible. For instance, a separate field in the uplink grant may be used to indicate the selected transport block.

Requesting a CSI-only report may be performed by setting one or more bits of a CSI request field in the uplink grant to a specified value. For instance, the network node 110 may set the CSI request field to 1 to indicate that a CSI-only report should be transmitted. Alternatively, the CSI request field may contain 2 bits, wherein a setting of 00 indicates that no CSI-only report is to be transmitted, and any other setting, i.e. 01, 11, or 10, indicates a request for a CSI-only report.

Another example method in a network node 110 according to an embodiment will now be described, again with reference to FIGS. 1 and 2. This embodiment is based on the previous example, except that the parameter to be signalled is an indication of one or more coordinated multipoint transmission points (CoMP transmission points) for which to measure and/or report CSI/CQI, where a transmission point constitutes a radio antenna array (possibly of a single antenna) covering a distinct geographical area. Alternatively, the parameter to be signalled is an indication of one or more reference symbol patterns (e.g., CSI-RS time/frequency patterns) for which to measure and/or report CQI/CSI for, where the association between the reference-symbol patterns and the transmission points may be transparent to the terminal. In such configurations, a reference symbol pattern could either be associated with a single transmission point, or be virtualized (transmitted) over multiple transmission points.

In another variant of the above examples, the parameter may be a CQI modality, e.g. an indication of one of several different reporting modalities targeting CoMP and non-CoMP scenarios. A CQI modality may also imply that different CoMP transmission schemes are associated with different CQI values and/or formats. In a particular example, the parameter is an indication of a reporting mode, e.g. CoMP or non-CoMP reporting. In yet further variants, the parameter may be a transmission rank, an indication of which component carrier to report CSI for, an index of a codeword on which to map the CSI report, or an indication of the layers which the CSI report should be mapped to.

With reference to FIG. 1 and the flowchart in FIG. 3, another example method in a network node 110 for requesting a channel state information-only, CSI-only, report from a wireless terminal 120 will now be described. As above, the network node 110 may be an LTE eNodeB and the wireless terminal 120 may be a user equipment, UE. This example is similar to the two embodiments described above, except that here, the selected transport block is used in combination with one or more other bits in the uplink grant to indicate one or more parameters.

In this particular example, one or more bits derivable from the indication of the selected transport block are combined with one or more other bits in the uplink grant to form a bitmap indicating for which component carriers the mobile terminal 120 should report CSI. In the scenario of FIG. 1, two component carriers (CCs) are available, CC 130 (CC1) and CC 140 (CC2). Thus, the bitmap consist of two bits, wherein the first bit indicates whether CSI should be reported for CC1, and the second bit indicates whether CSI should be reported for CC2. Setting a particular bit in the bitmap to 1 indicates that a CSI report should be transmitted for the corresponding CC, whereas 0 indicates that no CSI report should be transmitted. Of course, it is also possible to let the first bit indicate CC2, and the second bit indicate CC1, as well as letting a setting of 0 signify that a CSI report should be transmitted.

The selected transport block is used to indicate the value of the first bit in the bitmap, and another bit, e.g. the new data indicator (NDI) for the non-selected transport block, is used to indicate the value of the second bit.

In step 310, network node 110 selects a transport block out of two or more available transport block based on a parameter related to transmission of the CSI-only report which is to be requested. Thus, this step corresponds to step 210 above. In this particular example, network node 110 selects a transport block based on the value of the first bit in the bitmap. For instance, selecting TB1 may indicate that the value of the first bit is 0, i.e. no CSI transmission for CC1, whereas selecting TB2 may indicate that the value of the first bit is 1, i.e. CSI should be transmitted for CC1. As already discussed above, other encoding methods are also possible, as long as the network node 110 and mobile terminal 120 are both aware of which encoding method is applied.

In step 320, one or more other bits in the uplink grant are also used to indicate the at least one parameter. In this example, the new data indicator (NDI) field in the non-selected transport block is set to a value corresponding to the second bit in the bitmap. Alternatively, one or more bits of a MCS field or CSI request field may be used. Notably, if the CSI request field comprises more than one bit, some bit combinations may be redundant and could be used to encode part of the bitmap. For instance, the first bit of the CSI request field may be used to indicate whether a CSI-only report should be transmitted, leaving the second bit available for encoding a parameter, such as a part of the bitmap of the present example. It is also possible to use several or all of these bits together to transmit a larger bitmap, for example if there are more than two CCs configured for mobile terminal 210.

In step 330, the network node 110 transmits the uplink grant to the wireless terminal 120. This step corresponds to step 220 which has already been described above.

Although in this example, the parameter is a bitmap indicating for which CCs a CSI report should be transmitted, it should be realized that the parameter does not have to be represented by a bitmap, and that other parameters may be transmitted using the same method. For instance, the parameter may be one or more of a CQI modality, a modulation order, a transmission rank, an indication of one or more coordinated multipoint transmission points for which to report CSI, an index of a codeword on which to map the CSI report, or an indication of the layers which the CSI report should be mapped to

In particular variants, two or more parameters are jointly encoded using the combination of available bits as described above. The jointly encoded parameters may be any of the ones indicated above.

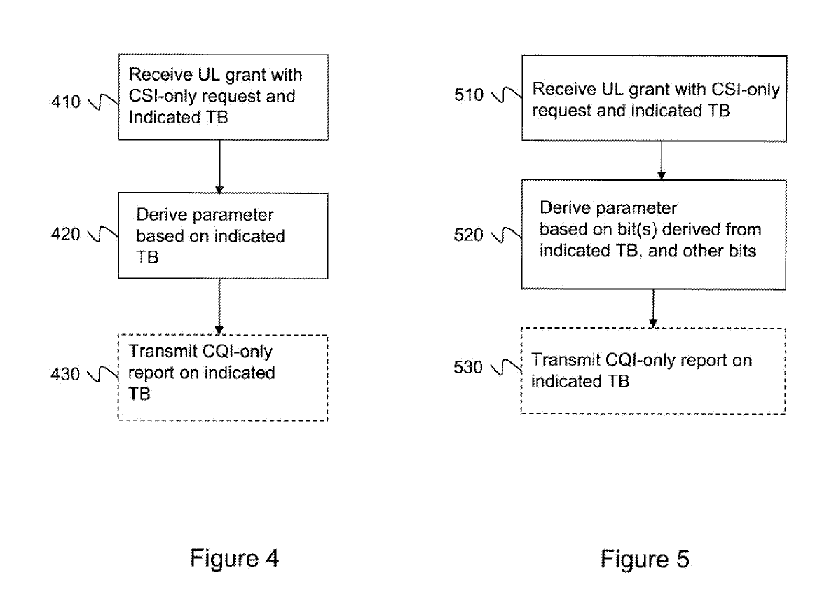

With reference to FIG. 1 and the flowchart in FIG. 4, an example method in a wireless terminal 120 for transmitting a channel state information-only, CSI-only, report to a network node 110 will now be described. The network node 110 may be an LTE eNodeB and the wireless terminal 120 may be a user equipment, UE.

In step 410, the wireless terminal 120 receives an uplink grant from network node 110 on a Physical Downlink Control Channel, PDCCH. The uplink grant may be received using a DCI format such as DCI format 4. The uplink grant comprises a request for a CSI-only report, and indicates a selected transport block, out of two or more available transport blocks. The CSI-only request, and the transport block selection, may be indicated as described above in connection with FIGS. 2 and 3.

The wireless terminal 120 then derives 420 at least one parameter related to transmission of the CSI-only report based on the indication of the selected transport block. In this example, the parameter is the modulation order to be used when transmitting the CSI-only report. If transport block 1 is indicated, the wireless terminal 120 derives that QPSK modulation should be used, and if transport block 2 is selected, the wireless terminal 120 derives that 16QAM should be used. Thus, in this example, the modulation order may be derived from the index (1 or 2) of the selected transport block. As explained above, other encodings are also possible.

In step 430, the wireless terminal 120 transmits the CSI-only report according to the derived parameter on a Physical Uplink Shared Channel, PUSCH. In the present example, wireless terminal 120 thus transmits the CSI-only report using QPSK modulation if TB1 was selected, and with 16QAM modulation if TB2 was selected. In some variants, the wireless terminal 120 also transmits the CSI-only report on the indicated transport block. However, it should be noted that depending on the implementation, wireless terminal 120 does not necessarily have to follow the transport block indication. For example, wireless terminal 120 may be hardcoded or preconfigured to always use transport block 1 for transmitting CSI-only reports. In this case, the transport block indication would only serve as an indication of the parameter, i.e. the modulation order in this example.

In other variants of the above examples, the parameter may be a CQI modality, a transmission rank, an indication of which component carrier to report CSI for, an index of a codeword on which to map the CSI report, or an indication of the layers which the CSI report should be mapped to.

Furthermore, although uplink grants are transmitted on the PDCCH, and CSI-only reports are transmitted on the PUSCH according to the current LTE standard, it is of course equally possible to use other channels to transmit this information.

With reference to FIG. 1 and the flowchart in FIG. 5, another example method in a wireless terminal 120 for transmitting a channel state information-only, CSI-only, report to a network node 110 will now be described. As above, the network node 110 may be an LTE eNodeB and the wireless terminal 120 may be a user equipment, UE. This example corresponds to the one described in FIG. 3, but seen from the perspective of the wireless terminal 120. Thus, in this particular example, one or more bits derivable from the indication of the selected transport block are combined with one or more other bits in the uplink grant to form a bitmap indicating for which component carriers the mobile terminal 120 should report CSI. The one more other bits are not used for triggering the CSI-only report, and may therefore be used to indicate another parameter or parameters. It should be noted that the bits could be used to indicate other parameters instead of, or in addition to, the component carriers for which to report CSI, as has already been described above.

The selected transport block is used to indicate the value of the first bit in the bitmap, and another bit, e.g. the new data indicator (NDI) for the non-selected transport block, is used to indicate the value of the second bit.

In step 510, the wireless terminal 120 receives an uplink grant from network node 110. This step corresponds to step 410. The uplink grant comprises a request for a CSI-only report, and indicates a selected transport block, out of two or more available transport blocks.

In step 520, wireless terminal 120 derives at least one parameter related to transmission of the CSI-only report. This step is similar to step 420, but in this example the wireless terminal 120 derives the at least one parameter from one or more other bits in the uplink grant in combination with one or more bits derived from the indication of the selected transport block.

The one or more other bits may comprise the new data indicator for the selected or non-selected transport block, or one or more bits of a CSI request field, or one or more bits of a modulation coding scheme field for the selected or non-selected transport block.

As described above in connection with FIG. 3, the one or more other bits combined with one or more bits derived from the indication of the selected transport block may be interpreted as a bitmap indicating for which component carriers to report CSI.

In particular variants, two or more parameters are jointly decoded based on the combination of available bits as described above. The jointly decoded parameters may be any of the ones indicated above.

In step 530, the wireless terminal 120 transmits the CSI-only report according to the derived parameter. According to the present example, the wireless terminal will thus include CSI measurements for each of the component carriers indicated by the bitmap in the CSI-only report. The wireless terminal 120 may or may not follow the transport block indication, as has been described above in connection with FIG. 4.

As explained above, in the current standard, in order to disable a transport block, the MCS (Modulation and Coding Scheme) field is set to a predefined value, e.g. 0. Conversely, setting the MCS field to 29, in combination with a certain setting of the NPRB field, indicates that the corresponding transport block is enabled, i.e. selected. However, in particular embodiments, another mechanism could be used to indicate whether a transport block is enabled or disabled. For instance, a new field could be defined for indicating the index of the selected, i.e. enabled, transport block. The MCS and NDI fields for two PUSCH codewords are always present in the grant, even when CQI-only is scheduled and thus no PUSCH transmission is triggered. Therefore, in particular embodiments, the content of the MCS field for one or more of the codewords may be redefined to carry a parameter, or part of a parameter, related to CQI-only transmission. It is also possible to use the MCS field in combination with the NDI field to carry the parameter. Different triggering methods are listed in the following, and for each of them it is illustrated how to exploit the unused MCS and NDI fields in order to signal CQI-related parameters.

One example set of conditions for triggering CQI-only transmission in case of DCI format 4 is as follows:
Condition 1: Single enabled TB (or rank-1 transmission),
Condition 2: NDI of a disabled TB=1,
Condition 3: CQI request=1, 01, 10 or 11.

If these triggering conditions are used, transmission of CQI-related parameters could be encoded by mapping CQI-related parameters to some code points on the MCS and/or NDI field in DCI-4 associated with the selected TB. This embodiment may be combined with the above embodiments where the transport block indication is used to encode a parameter, or part of a parameter.

It should be noted that in this embodiment, and some of the ones exemplified below, the N_PRB field is not used as part of the CSI-only triggering conditions. This provides the additional advantage of avoiding scheduling restrictions. If the Rel-8/9 CQI-only triggering scheme is to be extended to Rel-10 in a straightforward way, the threshold for CQI-only triggering needs to be increased, e.g. to enable reporting from several component carriers. Taking into account that up to 5 component carriers may be simultaneously reported in Rel-10, the threshold (X) for allocation of CQI-only in Rel-10 may assume a very large value, resulting in an significant scheduling constraint.

A further example set of conditions for triggering CQI-only transmission in case of DCI format 4 is the following:
Condition 1: I_MCS for TB 1=29,
Condition 2: N_PRB<=X

In this example, transmission of CQI-related parameters may be achieved by mapping CQI-related parameters to some code points on the MCS and/or NDI field in DCI-4 associated to TB 2.

Yet another example set of conditions for triggering CQI-only transmission in case of DCI format 4 is presented below:
Condition 1: I_MCS for TB 2=29,
Condition 2: N_PRB<=X

In this case, transmission of CQI-related parameters may be done by mapping CQI-related parameters to some code points on the MCS and/or NDI field in DCI-4 associated to TB 1.

An example of the parameters that may be carried by the redefined fields in DCI-4, e.g. MCS and NDI fields as explained above, is a mapping table or bitmap defining the subset of carriers for which CQI reports are provided in case of multicarrier operation, similarly to previous embodiments.

As explained above, the CQI-related parameters may be related to, e.g. coding, modulation order and spatial processing for the CQI payload. As an example embodiment, the modulation order for the CQI-only payload may be signaled by the unused MCS and/or NDI field. In another example. the index of the codeword on which CQI-only is mapped is signaled by the MCS and/or NDI field. In another example, the modulation order for CQI-only and the selected codeword for CQI transmission are jointly encoded in the MCS and/or NDI fields.

A further example set of conditions triggering CQI-only transmission in case of DCI format 4 is the following:
Condition 1: Single enabled TB (or rank-1 transmission),
Condition 2: NDI of a disabled TB=1,
Condition 3: CQI request=1, 01, 10 or 11.

Transmission of CQI-related parameters may be done by mapping CQI modulation order and/or codeword selection assignments to some code points on the MCS and/or NDI field in DCI-4 associated to the selected TB. This embodiment may also be combined with the above embodiments where the transport block indication is used to encode a parameter, or part of a parameter.

A further example set of conditions triggering CQI-only transmission in case of DCI format 4 is the following:
Condition 1: I_MCS for TB 1=29,
Condition 2: N_PRB<=X

In this case, transmission of CQI-related parameters may be done by mapping CQI modulation order and codeword selection assignments to some code points on the MCS and/or NDI field in DCI-4 associated to the TB 2.

Yet another example set of conditions triggering CQI-only transmission in case of DCI format 4 is:
Condition 1: I_MCS for TB 2=29,
Condition 2: N_PRB<=X

Transmission of CQI-related parameters may be done by mapping CQI modulation order and codeword selection assignments to some code points on the MCS and/or NDI field in DCI-4 associated to TB 1.

Another family of examples of how to exploit redundant NDI bits, based on a different CQI-only triggered method, is the following, where I_MCSx represents the content of the MCS field for TB x:

Set of conditions triggering CQI-only transmission in case of DCI format 4:
Condition 1: I_MCS1=I_MCS2=29
Condition 2: N_PRB<=X,
Condition 3: CQI request=1, 01, 10 or 11.

Transmission of CQI-related parameters may then be achieved by mapping CQI modulation order and/or codeword selection assignments and/or information about the indexes of the component carriers associated to the CQI report to the NDI bits for one or both the TBs in DCI-4.

Information about the component carriers for which the CQI report is provided may be in the form of an index pointing to a pre-defined subset of the available component carriers. Such a subset may be statically pre-defined or dynamically defined by use of other signaling protocols. This applies to all embodiments where the parameter to be signaled is an indication of component carriers for which a CSI or CQI report is to be provided.

In the above examples the condition N_PRB<=X indicates that the assigned number of RBs should not exceed a certain threshold X. Such a threshold may be pre-defined or assigned as a function of other parameters such as the number of component carriers.

Obviously, the above embodiments may be merged so that the MCS, or another redefined field, may carry jointly encoded signaling relative to the subset of carriers signaled by CQI, the modulation order to be adopted for CQI, the index of the selected codeword for CQI transmission and possibly other transmission parameters.

Furthermore, while the above examples have been produced by considering DCI-4 as the baseline solution, the principles of these techniques are general to other DCI formats and can be readily applied to other signaling protocols with similar characteristics as DCI-4. For the same reason the techniques can be applied to both uplink and downlink signaling, in appropriate contexts.

Finally, it should be noted that only a subset of the information elements belonging to DCI-4 have been discussed above, as a complete description of the information elements is unnecessary to a complete understanding of the techniques described herein. Those skilled in the art will appreciate that a thorough description of the existing and proposed features of the PDCCH and the various DCI formats may be obtained from the relevant 3GPP standards, e.g., 3GPP TS 36.212 and 3GPP TS 36.213, and the documentation accompanying the updating of those standards for Release 10.

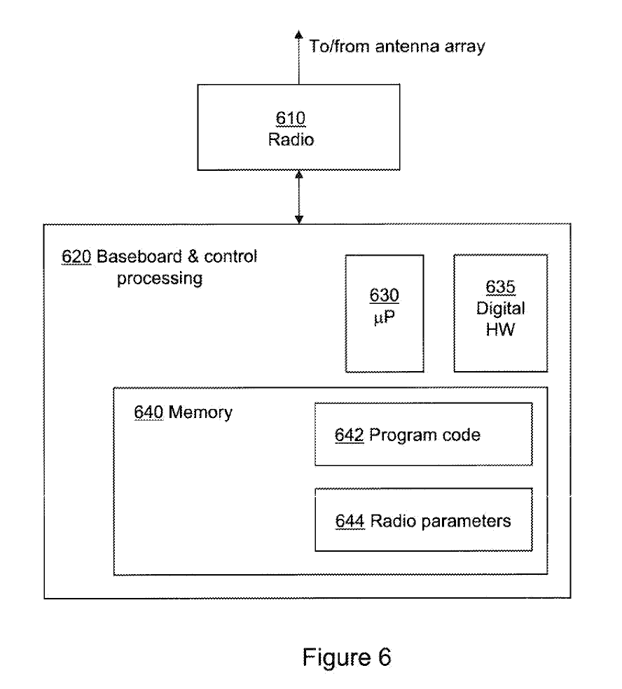

Those skilled in the art will further appreciate that practical embodiments of the techniques described above will include signaling methods, practiced in a base station such as an eNB, a mobile station such as a UE, or both, as well as devices, including base stations, e.g. eNBs, and mobile stations, e.g. UEs. In some cases, the methods/techniques described above will be implemented in a wireless transceiver apparatus such as the one pictured in FIG. 6, which illustrates a few of the components relevant to the present techniques, as realized in either a mobile station such as wireless terminal 120, or a network node such as network node 110, e.g. an eNB.

The pictured apparatus includes radio circuitry 610 and baseband & control processing circuit 620. Radio circuitry 110 includes receiver circuits and transmitter circuits that use known radio processing and signal processing components and techniques, typically according to a particular telecommunications standard such as the 3GPP standard for LTE-Advanced. Because the various details and engineering tradeoffs associated with the design of such circuitry are well known and are unnecessary to a full understanding of the invention, additional details are not shown here.

Baseband & control processing circuit 620 includes one or more microprocessors or microcontrollers 630, as well as other digital hardware 635, which may include digital signal processors (DSPs), special-purpose digital logic, and the like. Either or both of microprocessor(s) 630 and digital hardware may be configured to execute program code 642 stored in memory 640, along with radio parameters 644. Again, because the various details and engineering tradeoffs associated with the design of baseband processing circuitry for mobile devices and wireless base stations are well known and are unnecessary to a full understanding of the invention, additional details are not shown here.

The program code 642 stored in memory circuit 640, which may comprise one or several types of memory such as read-only memory (ROM), random-access memory, cache memory, flash memory devices, optical storage devices, etc., includes program instructions for executing one or more telecommunications and/or data communications protocols, as well as instructions for carrying out one or more of the techniques described herein, in several embodiments. Radio parameters 644 may include one or more pre-determined tables or other data for supporting these techniques, in some embodiments.

Particular embodiments of network node 110 will now be described with reference to FIG. 6 and the embodiments presented above in connection with FIGS. 3 and 4. The network node comprises radio circuitry 610 and one or more processing circuits 620. The one or more processing circuits 620 are configured to select, based on at least one parameter related to transmission of a CSI-only report, a transport block out of two or more available transport block, such that the at least one parameter is derivable from an indication of which transport block was selected. The one or more processing circuits 620 are further configured to transmit an uplink grant via radio circuitry 610 to a wireless terminal 120, the uplink grant comprising the request for the CQI-only report, and comprising an indication of the selected transport block.

The at least one parameter may be one or more of a CQI modality, a modulation order, a transmission rank, an indication of one or more coordinated multipoint transmission points for which to report CSI, an indication of one or more component carriers for which to report CSI, an index of a codeword on which to map the CSI report, or an indication of the layers which the CSI report should be mapped to.

In some variants, the processing circuits 620 are configured to also use one or more other bits in the uplink grant to indicate the at least one parameter, such that the at least one parameter is derivable from the one or more other bits in combination with one or more bits derivable from the indication of the selected transport block. The one or more bits are not used for triggering, e.g. requesting, the CSI-only report. The one or more other bits may comprise one or more of a new data indicator for a selected or non-selected transport block, one or more bits of a CSI request field, or one or more bits of a modulation coding scheme field for a selected or non-selected transport block.

In a particular variant, the processing circuits 620 are configured to combine one or more other bits with one or more bits derivable from the indication of the selected transport block to form a bitmap indicating for which component carriers to report CSI.

In some variants, the processing circuits 620 are configured to jointly encode two or more parameters using the one or more other bits combined with one or more bits derivable from the indication of the selected transport block.

The processing circuits 620 may be configured to transmit the uplink grant via radio circuitry 610 on a Physical Downlink Control Channel, PDCCH and using a downlink control information, DCI, format.

Particular embodiments of wireless terminal 110 will now be described with reference to FIG. 6 and the embodiments presented above in connection with FIGS. 5 and 6. The wireless terminal 120 comprises radio circuitry 610, and one or more processing circuits 620. The one or more processing circuits 620 are configured to receive an uplink grant comprising a request for a CSI-only report, wherein the uplink grant indicates a selected transport block, out of two or more available transport blocks. The one or more processing circuits 620 are further configured to derive at least one parameter related to transmission of the CSI-only report based on the indication of the selected transport block, for example from the index of the selected transport block. The processing circuits are further configured to transmit the CSI-only report via radio circuitry 610 according to the derived parameter.

The at least one parameter may be one or more of a CQI modality, a modulation order, a transmission rank, an indication of one or more coordinated multipoint transmission points for which to report CSI, an indication of one or more component carriers for which to report CSI, an index of a codeword on which to map the CSI report, or an indication of the layers which the CSI report should be mapped to.

In particular variants, processing circuits 620 are further configured to derive the at least one parameter from one or more other bits in the uplink grant in combination with one or more bits derived from the indication of the selected transport block, wherein the one or more other bits are not used for triggering the CSI-only report. The one or more other bits may comprise one or more of a new data indicator for a selected or non-selected transport block, one or more bits of a CSI request field, or one or more bits of a modulation coding scheme field for a selected or non-selected transport block.

In a particular variant, the processing circuits 620 are configured to derive a bitmap from the one or more other bits in combination with one or more bits derivable from the indication of the selected transport block, where the bitmap indicates for which component carriers to report CSI.

In some variants, the processing circuits 620 are configured to derive two or more parameters by jointly decoding the one or more other bits and the one or more bits derived from the indication of the selected transport block.

The processing circuits 620 may be configured to receive the uplink grant on a Physical Downlink Control Channel, PDCCH, using a downlink control information, DCI, format, via radio circuitry 610. The processing circuits 620 may be further configured to transmit the CSI-only report on a Physical Uplink Shared Channel, PUSCH, via radio circuitry 610.

Examples of several embodiments of the present invention have been described in detail above, with reference to the attached illustrations of specific embodiments. As it is not possible, of course, to describe every conceivable combination of components or techniques, those skilled in the art will appreciate that the present invention can be implemented in other ways than those specifically set forth herein, without departing from essential characteristics of the invention.

Note that although terminology from 3GPP LTE-Advanced has been used in this disclosure to exemplify the invention, this should not be seen as limiting the scope of the invention to only the aforementioned system. Other wireless systems including or adapted to include multi-layer transmission techniques may also benefit from exploiting the ideas covered within this disclosure.

Also note that terminology such as base station and UE should be considered non-limiting as applied to the principles of the invention. In particular, while detailed proposals applicable to the uplink in LTE-Advanced are described here, the described techniques may be applied to the downlink in other contexts.

Furthermore, it should be noted that the term “Channel State Information”, CSI, encompasses the term CQI. Thus, CQI is one example of CSI. However, CSI may comprise other or additional information, such as a rank indicator (RI). Thus, although certain examples herein refer to CQI or CQI-only reports, the concepts described apply equally to CSI or CSI-only reports in general.

When using the word “comprise” or “comprising” it shall be interpreted as non-limiting, i.e. meaning “consist at least of”.

The present invention is not limited to the above-describe preferred embodiments. Various alternatives, modifications and equivalents may be used. Therefore, the above embodiments should not be taken as limiting the scope of the invention, which is defined by the appending claims.

1-28. (canceled)

29. A method in a network node for requesting a channel state information-only, CSI-only, report from a wireless terminal, the method comprising:
selecting a transport block, out of two or more available transport blocks, based on at least one parameter related to transmission of a CSI-only report to be requested, such that the at least one parameter is derivable from an indication of which transport block was selected; and
transmitting to the wireless terminal an uplink grant that includes a request for the CSI-only report and includes an indication of the selected transport block.

30. The method of claim 29, wherein the indication of the selected transport block further indicates to the wireless terminal which transport block to use for transmitting the CSI-only report.

31. The method of claim 29, wherein the at least one parameter is derivable from an index of the selected transport block.

32. The method of claim 29, wherein the at least one parameter is one or more of: a channel quality indicator (CQI) modality, a modulation order, a transmission rank, an indication of one or more coordinated multipoint transmission points for which to report CSI, an indication of one or more reference symbol patterns for which to report CSI, an indication of one or more component carriers for which to report CSI, an index of a codeword on which to map the CSI report, and an indication of layers to which the CSI report should be mapped.

33. The method of claim 32, further comprising setting one or more bits in the uplink grant that are not used for requesting the CSI-only report to indicate the at least one parameter in combination with one or more other bits derivable from the indication of the selected transport block.

34. The method of claim 33, wherein the one or more bits comprise one or more of: a new data indicator, one or more bits of a CSI request field, or one or more bits of a modulation coding scheme field.

35. The method of claim 34, wherein the one or more bits comprise at least one of the new data indicator for a transport block not selected and one or more bits of the modulation coding scheme field for a transport block not selected.

36. The method of claim 34, wherein the one or more bits comprise at least one of the new data indicator for the selected transport block and one or more bits of the modulation coding scheme field for the selected transport block.

37. The method of claim 33, wherein the one or more bits combined with the one or more other bits derivable from the indication of the selected transport block form a bitmap indicating for which component carriers to report CSI.

38. The method of claim 33, further comprising jointly encoding two or more parameters using the one or more bits combined with the one or more other bits derivable from the indication of the selected transport block.

39. The method of claim 29, wherein the uplink grant is transmitted using a downlink control information, DCI, format.

40. The method of claim 29, wherein the uplink grant is transmitted on a Physical Downlink Control Channel, PDCCH.

41. The method of claim 29, wherein the network node is an evolved NodeB, eNB, and the wireless terminal is a user equipment.

42. A method in a wireless terminal for transmitting a channel state information-only, CSI-only, report to a network node, the method comprising:
receiving an uplink grant that includes a request for a CSI-only report and that indicates a selected transport block, out of two or more available transport blocks;
deriving at least one parameter related to transmission of the CSI-only report based on the indication of the selected transport block; and
transmitting the CSI-only report according to the derived parameter.

43. The method of claim 42, wherein transmitting the CSI-only report comprises transmitting the CSI-only report using the selected transport block.

44. The method of claim 42, wherein said deriving comprises deriving the at least one parameter from an index of the selected transport block.

45. The method of claim 42, wherein the at least one parameter is one or more of: a CQI modality, a modulation order, a transmission rank, an indication of one or more coordinated multipoint transmission points for which to report CSI, an indication of one or more reference symbol patterns for which to report CSI, an indication of one or more component carriers for which to report CSI, and an index of a codeword on which to map the CSI report.

46. The method of claim 45, wherein said deriving comprises deriving one or more bits from the indication of the selected transport block and deriving the at least one parameter from those one or more bits in combination with one or more other bits in the uplink grant that are not used for requesting the CSI-only report.

47. The method of claim 46, wherein the one or more other bits comprise one or more of: a new data indicator, one or more bits of a CSI request field, and one or more bits of a modulation coding scheme field.

48. The method of claim 47, wherein the one or more other bits comprise at least one of the new data indicator for a transport block not selected and one or more bits of the modulation coding scheme field for a transport block not selected.

49. The method of claim 47, wherein the one or more other bits comprise at least one of the new data indicator of the selected transport block and one or more bits of the modulation coding scheme field of the selected transport block.

50. The method of claim 46, wherein the at least one parameter includes an indication of one or more component carriers for which to report CSI and wherein deriving that indication comprises forming a bitmap from the one or more other bits combined with the one or more bits derived from the indication of the selected transport block.

51. The method of claim 46, wherein said deriving comprises deriving two or more parameters by jointly decoding the one or more other bits and the one or more bits derived from the indication of the selected transport block.

52. The method of claim 42, wherein the uplink grant is received using a downlink control information, DCI, format.

53. The method of claim 42, wherein the uplink grant is received on a Physical Downlink Control Channel, PDCCH, and the CSI-only report is transmitted on a Physical Uplink Shared Channel, PUSCH.

54. The method of claim 42, wherein the network node is an evolved NodeB, eNB, and the wireless terminal is a user equipment.

55. A network node for requesting a channel state information-only, CSI-only, report from a wireless terminal, the network node comprising radio circuitry and one or more processing circuits, wherein the one or more processing circuits are configured to:
select a transport block, out of two or more available transport blocks, based on at least one parameter related to transmission of a CSI-only report to be requested, such that the at least one parameter is derivable from an indication of which transport block was selected; and
transmit to the wireless terminal, via the radio circuitry, an uplink grant that includes a request for the CQI-only report and includes an indication of the selected transport block.

56. A wireless terminal for transmitting a channel state information-only, CSI-only, report to a network node, the wireless terminal comprising radio circuitry, and one or more processing circuits, wherein the one or more processing circuits are configured to:
receive, via the radio circuitry, an uplink grant that includes a request for a CSI-only report and that indicates a selected transport block, out of two or more available transport blocks;
derive at least one parameter related to transmission of the CSI-only report based on the indication of the selected transport block; and
transmit the CSI-only report according to the derived parameter.
